(19) United States
(12) Patent Application Publication
(10) Pub. No.: US 2012/0243677 A1
(43) Pub. Date: Sep. 27, 2012

(54) HANDSET UNIT AND TELEPHONE DEVICE

(75) Inventors: TAI-SENG LAM, Taipei (TW); Chiung-Chi Lin, Taipei (TW); Li Hsin Tseng, Taipei (TW)

(73) Assignee: FLYTECH TECHNOLOGY CO., LTD., TAIPEI CITY (TW)

(21) Appl. No.: 13/071,612

(22) Filed: Mar. 25, 2011

(51) Int. Cl. H04M 1/00

(52) U.S. Cl. 379/428.01

(57) ABSTRACT

A telephone device having barcode scanning capability includes: a control module, a display unit, and a handset. The control module has a database and a processor electrically connected to the database. The display unit is electrically connected to the processor of the control module. The handset unit has a housing, a telephone module, a scanner, a switch, and a transmitter module, wherein the telephone module, the scanner, the switch and the transmitter module are disposed in the housing. The housing has a scanning port formed thereof. The telephone module has a listening component and a speaking component. The scanner has an optical reading unit corresponding to the scanning port of the housing. The switch is selectivity conducting to the telephone module or the scanner. The transmitter module is electrically connecting to the processor of the control module and the switch. Thus, the telephone device has scanning and communicating functions.

### BACKGROUND OF THE INVENTION

1. Field of the Invention

The instant disclosure relates to a handset unit and a telephone device; and more particularly, to a handset unit for a telephone device having barcode reading capability.

2. Description of Related Art

With the rapid advancement in wireless communication technology, research emphasis has been heavily placed on the development of mobile phones. While having a much shorter operational history than its fixed-line counterpart, modern cellular phones have been developed to incorporate handy functional add-ons such as on board cameras, digital music players, and even audio/video recording devices. In comparison, their fixed-line ancestors lag behind in receiving modern technological upgrades.

Therefore, one aspect of the instant disclosure is to provide a handset unit and a telephone device that incorporates the functionality of a bar code reader, thus providing enhanced practical utility over conventional telephone devices.

### SUMMARY OF THE INVENTION

One object of the instant disclosure is to provide a handset unit and a telephone device, wherein the handset unit and the telephone device are provided with barcode-scanning function for making the handset unit and the telephone device more variety.

The telephone device in accordance with the instant disclosure includes a control module, a display unit, and a handset unit. The control module comprises a processor and an associated database. The display unit is electrically connected to the control module of the phone system for displaying relevant information. The handset unit has a housing, a telephone module, a scanner module, a switch, and a transmitter module. The telephone module, the scanner module, the switch and the transmitter module are disposed in the housing. The housing further includes a scanning port formed thereon. The telephone module has a listening component and a speaking component. The scanner module has an optical reading unit correspondingly arranged with respect to the scanning port of the housing. The switch selectivity connects the telephone module and the scanner module to the transmitter module. The transmitter module is electrically connecting to the processor of the control module and the switch.

The handset unit in accordance with the instant disclosure includes: a housing, a telephone module, a scanner, a switch, and a transmitter module. The housing has a scanning port formed thereon. The telephone module has a listening component and a speaking component. The scanner has an optical reading unit corresponding to the scanning port of the housing. The switch is selectivity conducted to the telephone module or the scanner. The transmitter module is electrically connected to the switch. The telephone module, the scanner, the switch and the transmitter module are disposed in the housing.

The telephone device is particularly suitable for disposing beside a hospital bed to scan a barcode associated with a hospital patient. The instant telephone system includes: a control module, a display unit, and a handset unit. The control module comprises a processor and an associated database for storing a plurality of patient data. The barcode is configured in correspondence to one of the patient data. The display unit is electrically connected to the control module. The handset unit has a housing, a telephone module, a scanner module, a switch, and a transmitter module. The telephone module, the scanner, the switch and the transmitter module are disposed in the housing. The housing has a scanning port formed thereon. The telephone module has a listening component and a speaking component. The scanner has an optical reading unit arranged correspondingly to work with the scanning port of the housing. The switch is selectivity connected to the telephone module or the scanner. The transmitter module is electrically connecting to the processor of the control module and the switch. Thus, the optical reading unit can be used for reading the barcode, and the barcode information processed by the control module can be presented on the display unit.

The instant disclosure provides the handset unit and telephone device with communicating and scanning functions.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a schematic view illustrating the handset unit of the instant disclosure.

FIG. 2 is an exploded schematic view illustrating the handset unit of the instant disclosure.

FIG. 3 is a functional diagram illustrating the instant disclosure.

FIG. 4 is a functional diagram illustrating the scanner of the instant disclosure.

FIG. 5 is a functional diagram illustrating the wireless transmitter module of the instant disclosure.

FIG. 6 is a schematic view illustrating the second embodiment of the instant disclosure.

FIG. 7 is a functional diagram illustrating the second embodiment of the instant disclosure.

FIG. 8 is a schematic view illustrating the third embodiment of the instant disclosure.

FIG. 9 is a functional diagram illustrating the third embodiment of the instant disclosure.

### DETAILED DESCRIPTION OF THE PREFERRED EMBODIMENTS

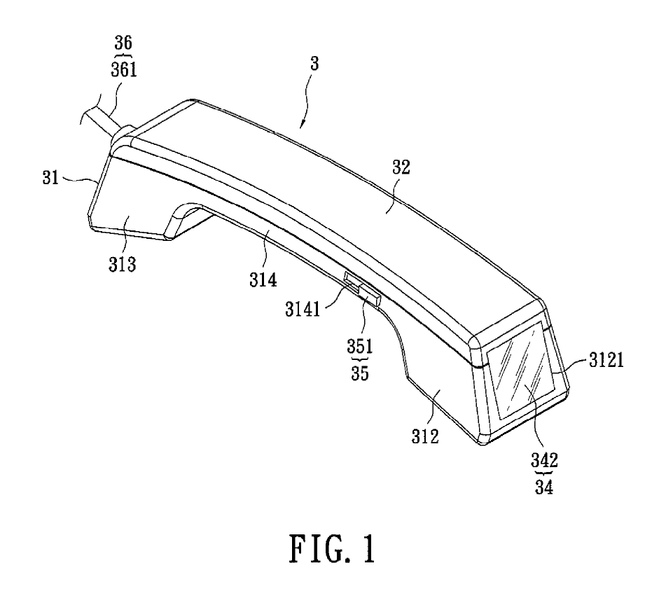

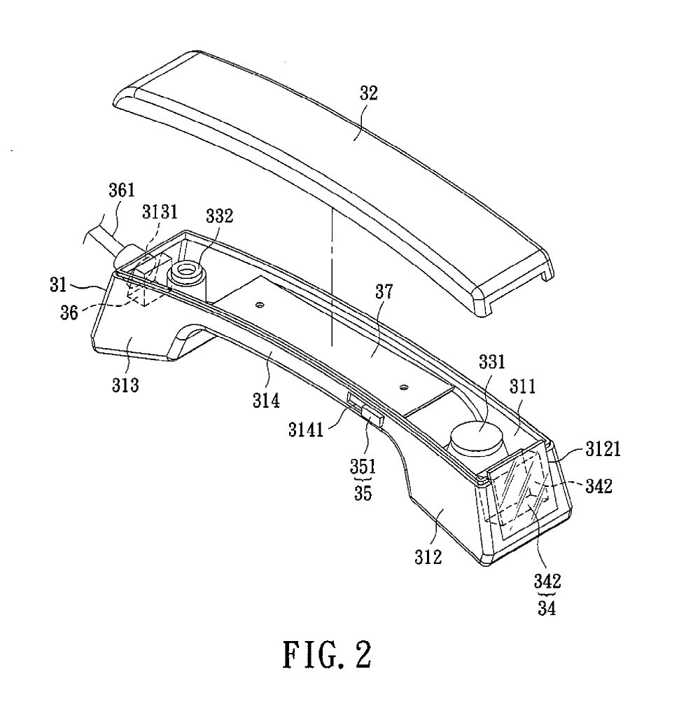

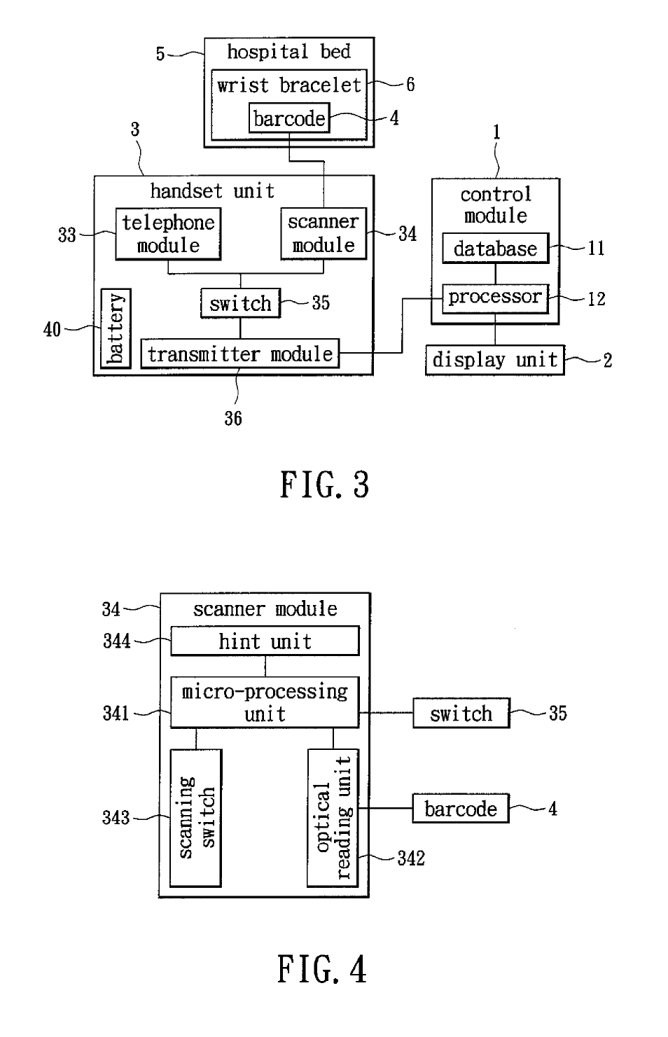

Please refer to FIGS. 1-5, which show the first embodiment of the instant disclosure. As FIGS. 2 and 3 shown, a telephone device could be used to scan a barcode 4 for getting information corresponding to the barcode 4. The telephone device has a control module 1, a display unit 2 electrically connected to the control module 1, and a handset unit 3.

The control module 1 has a database 11 and a processor 12 electrically connected to the database 11. The database 11 is stored a plurality of data (not shown), each datum is corresponded to one barcode 4. The display unit 2 is electrically connected to the processor 12 of the control module 1. The processor 12 can transmit the datum corresponded to the barcode 4 to the display unit 2, and then the display unit 2 is presented the datum information.

The handset unit 3 has a housing made of a lower portion 31 and an upper portion 32, a telephone module 33, a scanner 34, a switch 35, and a transmitter module 36, wherein the telephone module 33, the scanner 34, the switch 35 and the transmitter module 36 are disposed in the housing 31, 32 and each has a circuit module (not shown) formed on a circuit board 37. The switch 35 is selectivity conducting to the telephone module 33 or the scanner 34. The transmitter module 36 is electrically connecting to the processor 12 of the control module 1 and the switch 35.

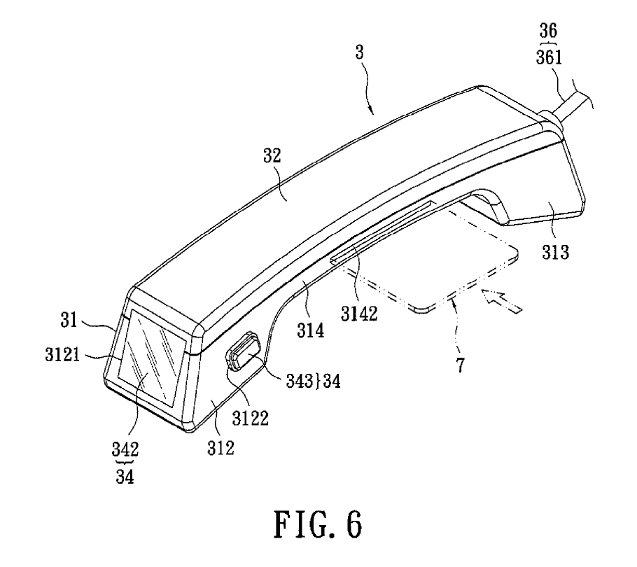

The housing 31, 32 has a recessed base 31 and a cover 32 mounted on the recessed base 31. The recessed base 31 has a handheld portion 314, a listening portion 312 and a speaking portion 313, and the recessed base 31 has an accommodated space 311 formed on the handheld portion 314, the listening portion 312 and the speaking portion 313 thereof. The listening and speaking portions 312, 313 are respectively extended from two ends of the handheld portion 314. The listening portion 312 has a scanning port 3121 and a pressing opening 3122 (as FIG. 6 shown) formed thereof. The speaking portion 313 has a transmitting opening 3131 formed thereof. The handheld portion 314 has a switching opening 3141 formed on one side approaching to the listening portion 312 thereof. Besides, the circuit board 37 can be disposed inside the handheld portion 314.

The telephone module 33 has a listening component 331, a speaking component 332, and other necessary electronic components (not shown). The listening component 331 is disposed in the listening portion 312 of the recessed base 31. The speaking component 332 is disposed in the speaking portion 313 of the recessed base 31.

The scanner 34 has a micro-processing unit 341, an optical reading unit 342, a scanning switch 343, and a hint unit 344 (as FIG. 4 shown). The optical reading unit 342, the scanning switch 343, and the hint unit 344 are electrically connected to the micro-processing unit 341. The optical reading unit 342 is disposed in the listening portion 312, and one end of the optical reading unit 342 is fixed and corresponding to the scanning port 3121 of the housing 31, 32. The scanning switch 343 is disposed in the housing 31, 32 and protruded from the pressing opening 3122 of the listening portion 312.

The switch 35 has a switching button 351 disposed in the handheld portion 314 and protruded from the switching opening 3141. The switching button 351 is movably disposed in the switching opening 3141 of the handheld portion 314 for selectivity conducting to the telephone module 33 or the scanner 34.

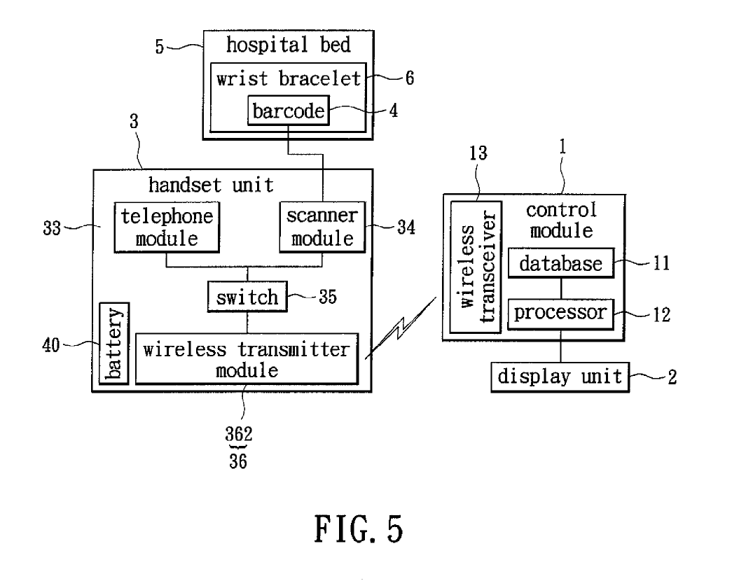

The transmitter module 36 is disposed in the speaking portion 313 and corresponded to the transmitting opening 3131 of the speaking portion 313. The handset unit 3 has a transmission cable 361. One end of the transmission cable 361 is passing through the transmitting opening 3131 to connect to the transmitter module 36, and the other end is electrically connected to the processor 12 of the control module 1. Thus, the handset unit 3 and the control module 1 can be achieved electrically connection and signal transmission with each other. Further, the transmitter module 36 can be a wireless transmitter module 362 (as FIG. 5 shown), and the control module 1 has a wireless transceiver 13 disposed therein, which the wireless transceiver 13 is electrically connected to the wireless transmitter module 362. Thus, the handset unit 3 and the control module 1 can be achieved electrically connection and signal transmission with each other by wireless connecting type.

If adjusting the switching button 351 to make the switch 35 conducting to the telephone module 33, the handset unit 3 is used for communicating.

If adjusting the switching button 351 to make the switch 35 conducting to the scanner 34, the handset unit 3 is used for scanning. That is to say, when pressing the scanning switch 343, the optical reading unit 342 of the scanner 34 is reading a photo signal of the barcode 4, the micro-processor unit 341 transfers the photo signal of the barcode 4 into a digital signal, and then, the switch 35 and the transmitter module 36 transmit the digital signal to the processor 12, the processor 12 is seeking an information corresponded to the digital signal from the database 11, and the processor 12 transmits the information to the display unit 2 for displaying the information.

If the photo signal of the barcode 4 is transferred to the digital signal, which means the scanning process is achieved, and then the hint unit 344 will produce a beeping to notice the user.

Therefore, the telephone device has a scanning function to provide a variety using mode. Besides, a battery 40 can be disposed in the handset unit 3 for supplying energy to the above units of the handset unit 3.

The best field for the telephone device of the instant disclosure is related a medical treatment. The telephone device is disposed beside a hospital bed 5 to scan a barcode 4 of a wrist bracelet 6 disposed with a patient laid on the hospital bed 5. The database 11 is stored a plurality of patient data, wherein the barcode 4 is corresponded to one of the patient data. Thus, when a medical staff diagnoses or takes care of the patient, the medical staff can use the handset unit 3 to scan and read the barcode 4 of the wrist bracelet 6, and then the display unit 2 will be presented the patient data corresponding to the barcode 4 immediately. So that, the medical staff can be faster and easier to realize the condition of the patient.

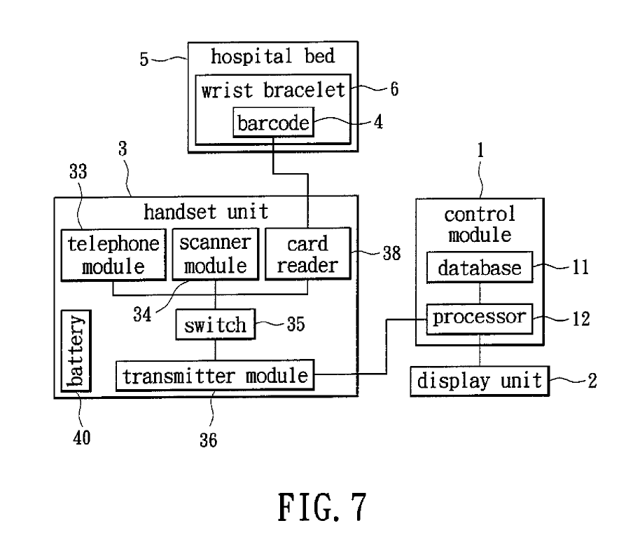

Please refer to FIGS. 6 and 7, which illustrating the second embodiment of the instant disclosure. The difference between the first and second embodiments is as follows.

The handheld portion 314 of the recessed base 31 further has an inserting opening 3142 formed on the other side thereof. The handset unit 3 further has a card reader 38 disposed in the housing 31, 32 and corresponding to the inserting opening 3142 of the handheld portion 314. The circuit module of the card reader 38 can be formed on the circuit board 37. A card 7 can be inserted into the reader 38 via the inserting opening 3142 of the handheld portion 314, the information of the card 7 can be read by the card reader 38.

The switching button 351 is movably disposed in the switching opening 3141 of the handheld portion 314 for selectivity conducting to the telephone module 33, the scanner 34, or the card reader 38.

Besides, the card reader 38 is a type for reading an IC card (such as a credit card, easy card, or health insurance card), or the card reader 38 is another type for reading a memory card or a USB connector (not shown).

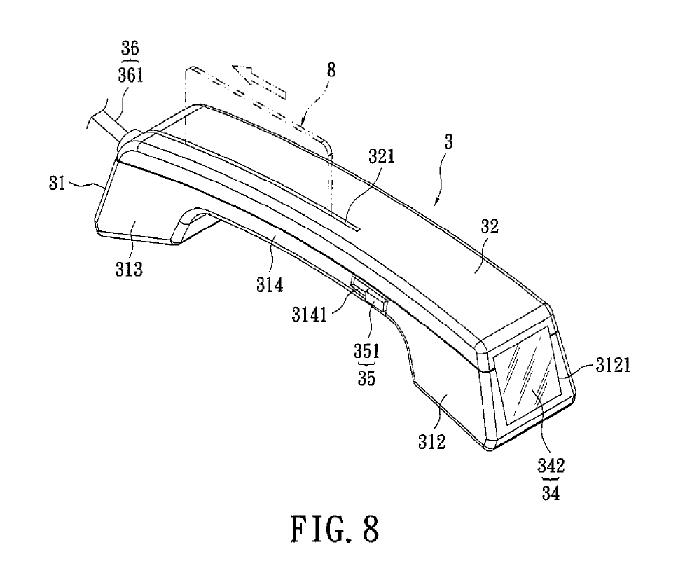

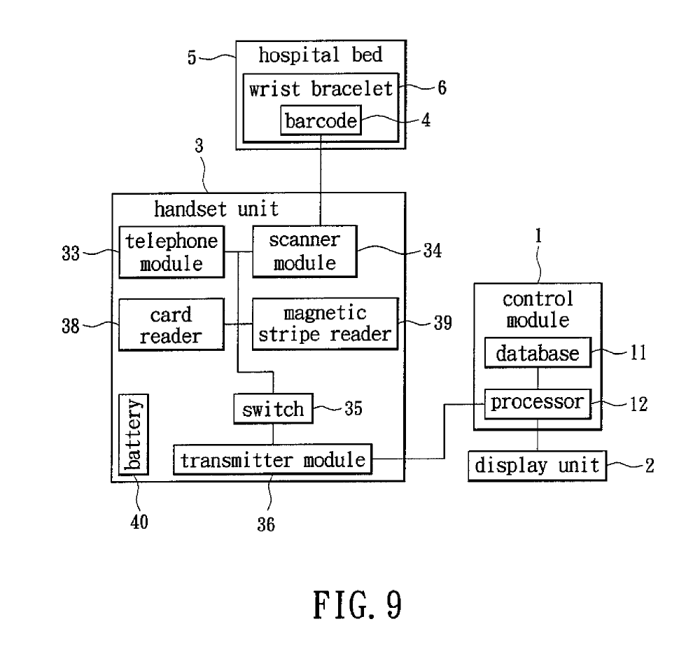

Please refer to FIGS. 8 and 9, which illustrating the third embodiment of the instant disclosure. The difference between the first and third embodiments is as follows.

The cover 32 has an elongated channel 321 formed on a portion corresponded to the listening portion 313 and the handheld portion 314 thereof. The handset unit 3 further has a magnetic stripe reader (MSR) 39 disposed in the housing 31, 32 and corresponding to the elongated channel 321 of the cover 32. The circuit module of the magnetic stripe reader 39 can be formed on the circuit board 37. A magnetic card 8 is swiped through the magnetic stripe reader 39 via elongated channel 321 of the cover 32, the information of the magnetic card 8 can be read by the magnetic stripe reader 39. Besides, the instant disclosure can has the card reader 38 and the magnetic stripe reader 39 at the same time.

The switching button 351 is movably disposed in the switching opening 3141 of the handheld portion 314 for selectivity conducting to the telephone module 33, the scanner 34, the card reader 38, or the magnetic stripe reader 39.

The instant disclosure provides several advantages. First, the telephone device has multi-function, which includes communicating, scanning, and card-reading, to provide a variety and convenience using mode for the user. Second, the medical staff can be faster and easier to realize the condition of the patient by the handset unit 3 or the telephone device with scanning the barcode 4.

The description above only illustrates specific embodiments and examples of the instant disclosure. The instant disclosure should therefore cover various modifications and variations made to the herein-described structure and operations of the instant disclosure, provided they fall within the scope of the instant disclosure as defined in the following appended claims.

What is claimed is:

1. A telephone device capable of scanning a barcode, comprising
a control module comprising a processor and an associated database;
a display unit electrically connected to the control module; and
a handset unit comprising a housing, a telephone module, a scanner module, a switch, and a transmitter module, the telephone module, the scanner module, the switch and the transmitter module being disposed in the housing,
wherein the housing has a scanning port formed thereon,
wherein the telephone module has a listening component and a speaking component,
wherein the scanner module includes an optical reading unit correspondingly arranged with respect to the scanning port of the housing,
wherein the switch is operably disposed on the housing for establishing selective connection from the telephone module and the scanner module to the transmitter module, and
wherein the transmitter module provides signal communication to the control module.

2. The telephone device as claimed in claim 1, wherein the telephone module, the scanner, the switch, and the transmitter module each has a circuit module formed on a circuit board.

3. The telephone device as claimed in claim 1, wherein the housing has a recessed base and a cover mounted on the recessed base, the recessed base has a handheld portion, a listening portion and a speaking portion, the listening and speaking portions are respectively extended from two ends of the handheld portion, the recessed base has an accommodated space formed thereof, the listening component is disposed in the listening portion, the speaking component is disposed in the speaking portion.

4. The telephone device as claimed in claim 3, wherein the scanning port is formed on the listening portion, the optical reading unit is disposed in the listening portion.

5. The telephone device as claimed in claim 4, wherein the handheld portion has a switching opening formed on one side thereof, the switch has a switching button disposed in the handheld portion and movably disposed in the switching opening of the handheld portion.

6. The telephone device as claimed in claim 3, wherein the handheld portion has an inserting opening formed on one side thereof, the handset unit has a card reader disposed in the housing and corresponding to the inserting opening of the handheld portion.

7. The telephone device as claimed in claim 3, wherein the cover has an elongated channel, the handset unit has a magnetic stripe reader disposed in the housing and corresponding to the elongated channel of the cover.

8. The telephone device as claimed in claim 1, wherein the handset unit has a transmission cable connected to the control module and the transmitter module.

9. The telephone device as claimed in claim 1, wherein the transmitter module is a wireless transmitter module, the control module has a wireless transceiver electrically connected to the wireless transmitter module.

10. A handset unit, comprising:
a housing having a scanning port formed thereon,
a telephone module having a listening component and a speaking component disposed in the housing;
a scanner module having an optical reading unit disposed in the housing and correspondingly arranged with respect to the scanning port of the housing;
a transmitter module disposed in the housing; and
a switch operably disposed on the housing for establishing selective connection from the telephone module and the scanner module to the transmitter module.

11. The handset unit as claimed in claim 10, wherein the telephone module, the scanner, the switch, and the transmitter module each has a circuit module formed on a circuit board.

12. The handset unit as claimed in claim 10, wherein the housing has a recessed base and a cover mounted on the recessed base, the recessed base has a handheld portion, a listening portion and a speaking portion, the listening and speaking portions are respectively extended from two ends of the handheld portion, the recessed base has an accommodated space formed inside thereof, the listening component is disposed in the listening portion, the speaking component is disposed in the speaking portion.

13. The handset unit as claimed in claim 12, wherein the scanning port is formed on the listening portion, the optical reading unit is disposed in the listening portion.

14. The handset unit as claimed in claim 13, wherein the handheld portion has a switching opening formed on one side thereof, the switch has a switching button disposed in the handheld portion and movably disposed in the switching opening of the handheld portion.

15. The handset unit as claimed in claim 12, wherein the handheld portion of the recessed base has an inserting opening formed on one side thereof, the handset unit has a card reader disposed in the housing and corresponding to the inserting opening of the handheld portion.

16. The handset unit as claimed in claim 12, wherein the cover has an elongated channel, the handset unit has a magnetic stripe reader disposed in the housing and corresponding to the elongated channel of the cover.

17. A telephone device for disposing beside a hospital bed to scan a barcode associated with a patient, comprising:
a control module comprising a processor and an associated database for storing data corresponding to at least one barcode associated with the patient;
a display unit electrically connected to the control module; and
a handset unit comprising a housing, a telephone module, a scanner, a switch, and a transmitter module, the telephone module, the scanner, the switch and the transmitter module being disposed in the housing,
wherein the housing has a scanning port formed thereon,
wherein the telephone module has a listening component and a speaking component,
wherein the scanner module includes an optical reading unit correspondingly arranged with respect to the scanning port of the housing,
wherein the switch is operably disposed on the housing for establishing selective connection from the telephone module and the scanner module to the transmitter module,
wherein the transmitter module provides signal communication to the control module;
wherein in response to the barcode reading of the optical reading unit, the processor causes the display unit to present the data associated with the patient.

18. The telephone device as claimed in claim 17, wherein the housing has a recessed base and a cover mounted on the recessed base, the recessed base has a handheld portion, a listening portion and a speaking portion, the listening and speaking portions are respectively extended from two ends of the handheld portion, the recessed base has an accommodated space formed inside thereof, the listening component is disposed in the listening portion, the speaking component is disposed in the speaking portion.

19. The telephone device as claimed in claim 18, wherein the handheld portion of the recessed base has an inserting opening formed on one side thereof, the handset unit has a card reader disposed in the housing and corresponding to the inserting opening of the handheld portion.

20. The telephone device as claimed in claim 18, wherein the cover has an elongated channel, the handset unit has a magnetic stripe reader disposed in the housing and corresponding to the elongated channel of the cover.
